(19) United States
(12) Patent Application Publication
(10) Pub. No.: US 2009/0229386 A1
(43) Pub. Date: Sep. 17, 2009

(54) ELECTRIC POWER TAKE OFF MECHANISM

(76) Inventor: DENNIS BRANDON, Brentwood, TN (US)

Correspondence Address: W. EDWARD RAMAGE, COMMERCE CENTER SUITE 1000, 211 COMMERCE ST, NASHVILLE, TN, 37201, US

(21) Appl. No.: 12/402,449

(22) Filed: Mar. 11, 2009

Related U.S. Application Data
(60) Provisional application No. 61/035,390, filed on Mar. 11, 2008.

(51) Int. Cl. F16H 37/00

(52) U.S. Cl. 74/11

(57) ABSTRACT

A PTO engagement assembly comprising an electric motor mechanically connected to a lever arm through a set or series of gears. The electric motor turns both forward and backward, causing the lever arm to move forward and backward as well. A cable looped around the end of the lever arm (or otherwise connected or fastened to the lever arm at some point along the lever arm) moves inward or outward as the lever arm moves. The electric motor may controlled by an electric switch. Mounting holes and brackets may be used to fasten the PTO engagement assembly to the mower.

This application claims benefit of and priority to U.S. Provisional Application No. 61/035,390, filed Mar. 11, 2008, by Dennis Brandon, and entitled to that filing date for priority. The specification, drawings, and complete disclosure of U.S. Provisional Application No. 61/035,390 are incorporated herein by reference.

### FIELD OF INVENTION

This invention relates to an electric Power Take Off (PTO) mechanism for engaging and disengaging the cutting blades of a lawnmower.

### BACKGROUND OF THE INVENTION

Riding lawnmowers have either a manual or an electric PTO (Power Take Off) switch or mechanism to engage the cutting blades of the mower. The electric PTO versions are generally found on upscale or more expensive models, and are preferred from a convenience perspective. An electric PTO system normally includes an electric (magnetic) clutch, idler pulley, and an electrical switch. However, this system has several disadvantages: (1) it is more expensive (estimated $42-45 @ OEM cost); (2) it requires an engine with an upgraded alternator; (3) it requires a different set of pulleys than the manual version; (4) it is bad for the v-belts due to the shock load at engagement; and (5) clutches have a rather high failure rate, causing increased warranty costs.

Most of the current models using manual engagement utilize a lever-arm that is rotated by the operator. The lever-arm when rotated pulls a cable connected to a fixed bracket, spring and idler pulley on the cutting deck. When the lever-arm is in the engaged position, the cable pulls the idler pulley that takes the slack out of the drive belts thus engaging the blades. A spring between the fixed bracket and idler pulley is used to keep slack out of the cable and pull the idler pulley away from the belts to disengage the blades. The manual assembly normally mounts on the underside of the dash with the cable going from the assembly down to the fixed bracket, spring, and idler pulley located on the cutting deck.

Accordingly, what is needed is a electric PTO engagement mechanism with the convenience of current electric PTO systems, but that functions without the significant disadvantages of those systems.

### SUMMARY OF INVENTION

In one exemplary embodiment, a PTO engagement assembly comprises an electric motor mechanically connected to a lever arm through a set or series of gears. The electric motor turns both forward and backward, causing the lever arm to move forward and backward as well. A cable looped around the end of the lever arm (or otherwise connected or fastened to the lever arm at some point along the lever arm) moves inward or outward as the lever arm moves. The electric motor may controlled by an electric switch. Mounting holes and brackets may be used to fasten the PTO engagement assembly to the mower.

In another exemplary embodiment, the set of gears comprises a pinion gear that engages a drive gear. The drive gear teeth may comprise only a portion of a circle, and the lever arm may extend from the other side. The drive gear may rotate on a pivot bushing.

Still other advantages of various embodiments will become apparent to those skilled in this art from the following description wherein there is shown and described exemplary embodiments of this invention simply for the purposes of illustration. As will be realized, the invention is capable of other different aspects and embodiments without departing from the scope of the invention. Accordingly, the advantages, drawings, and descriptions are illustrative in nature and not restrictive in nature.

### BRIEF DESCRIPTION OF THE DRAWINGS

FIG. 1 is a perspective view of one embodiment of a PTO engagement assembly in accordance with one exemplary embodiment of the present invention.

FIGS. 2 through 5 show top, bottom, and side views of the PTO engagement assembly of FIG. 1.

FIG. 6 shows perspective views of the pinion gear, drive gear, and pivot bushing.

FIG. 7 shows an exploded view of the PTO engagement assembly of FIG. 1.

### DETAILED DESCRIPTION OF EXEMPLARY EMBODIMENTS

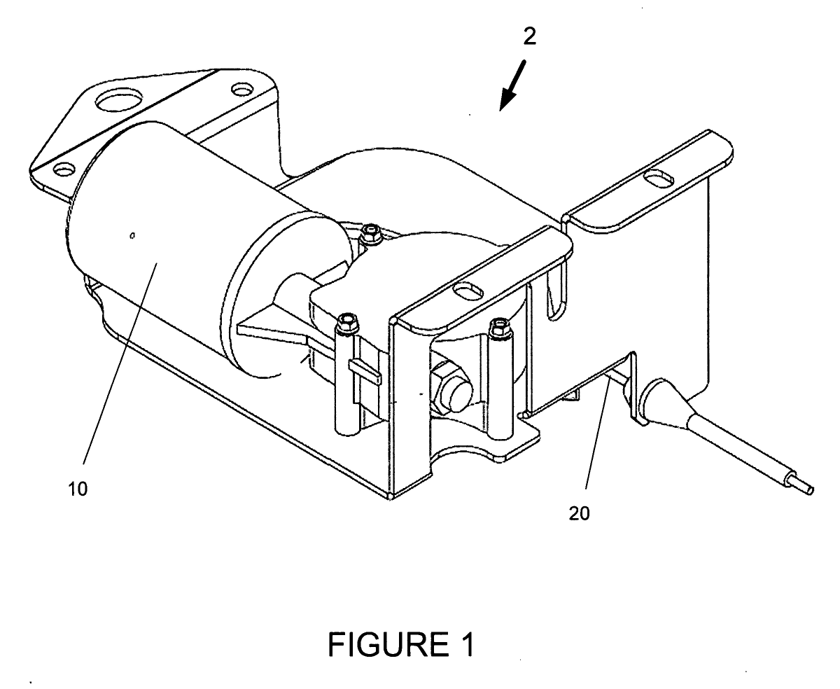

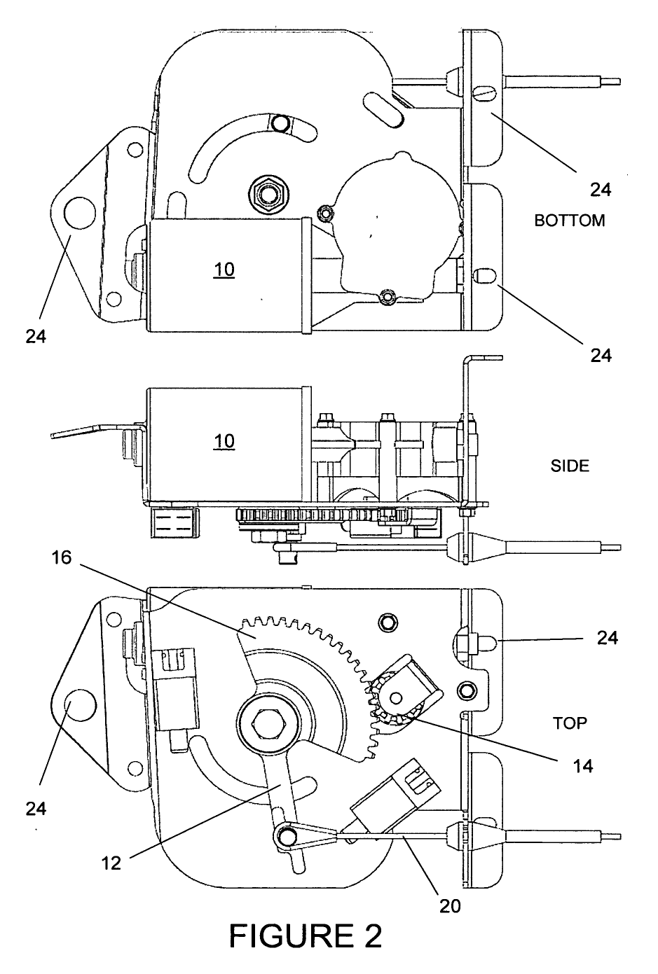

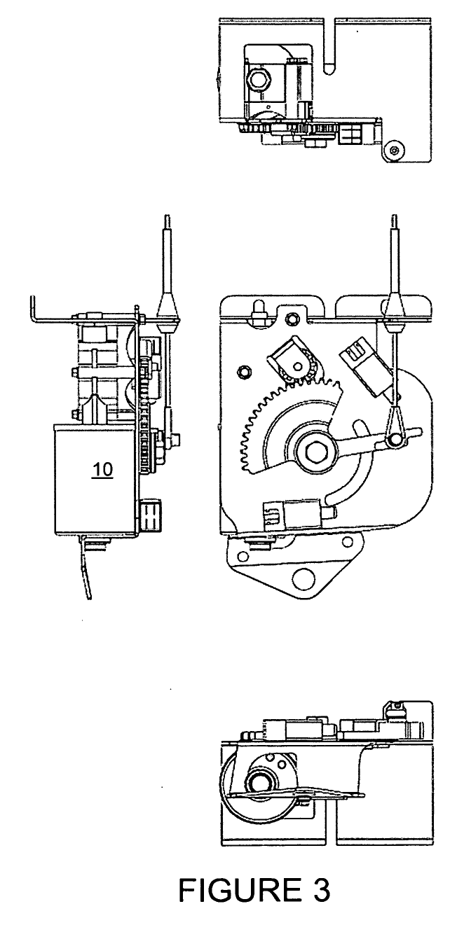

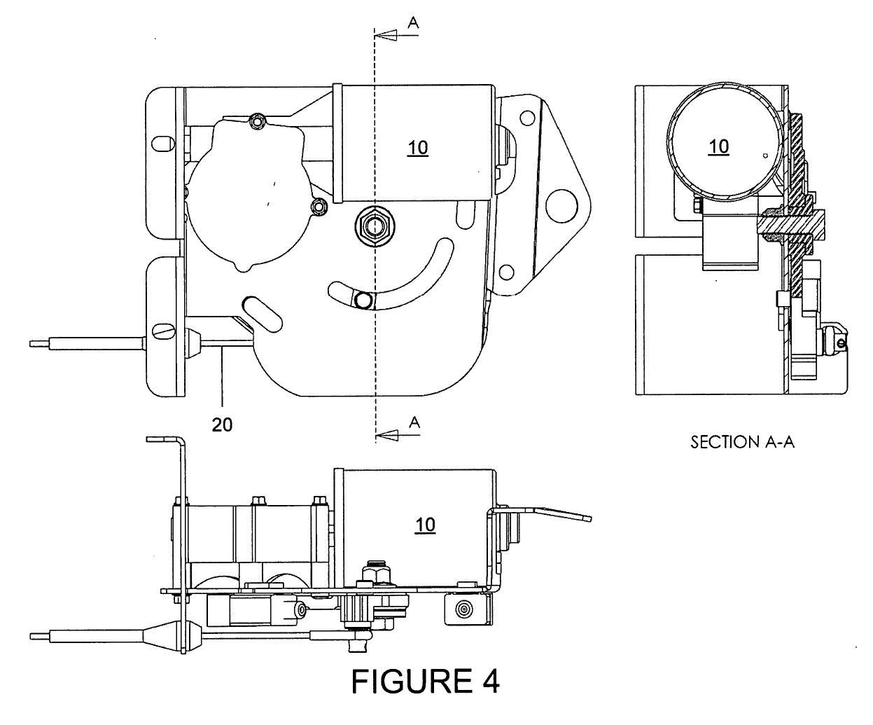

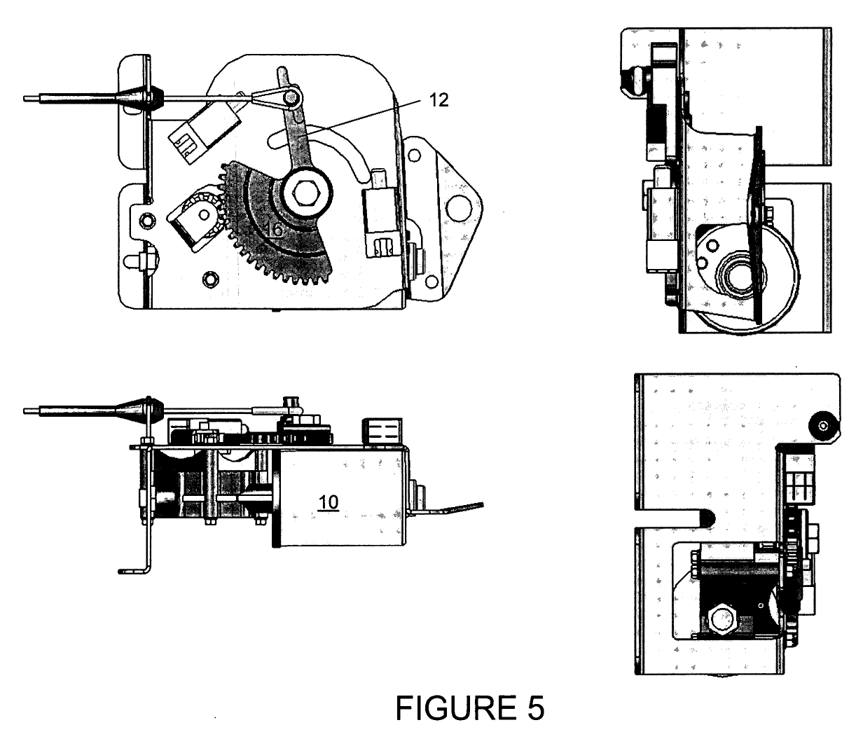

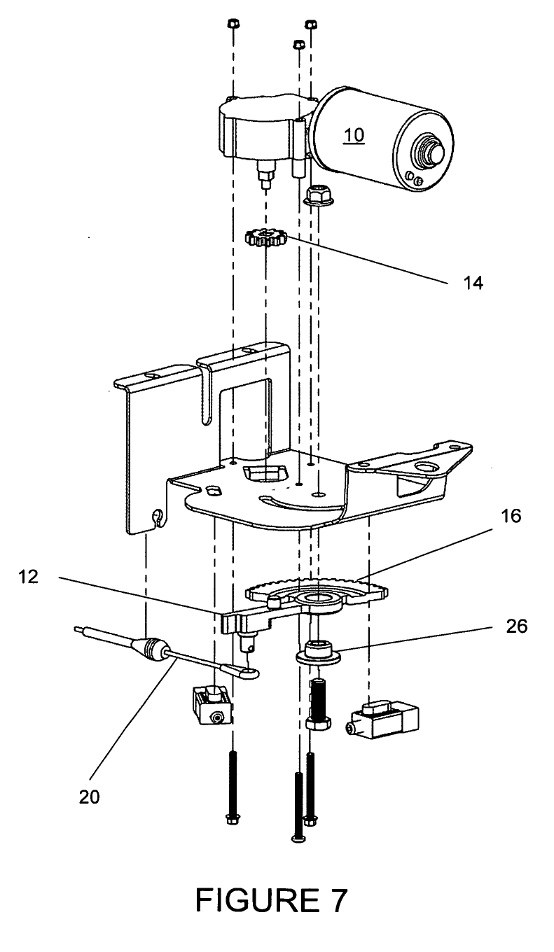

As shown in FIGS. 1 through 7, in one exemplary embodiment, a PTO engagement assembly 2 comprises an electric motor 10 mechanically connected to a lever arm 12 through a set of gears 14, 16. The electric motor 10 turns both forward and backward, causing the lever arm 12 to move forward and backward as well. A cable 20 looped around the end of the lever arm 12 (or otherwise connected or fastened to the lever arm 12 at some point along the lever arm) moves inward or outward as the lever arm 12 moves. The cable 20, and all parts of the cutting deck normally used or found in a manual configuration (not shown), may be essentially the same as found therein. The electric motor 10 may controlled by an electric switch on the mower control panel, or elsewhere (not shown).

Mounting holes and brackets 24 may be used to fasten the PTO engagement assembly 2 to the mower.

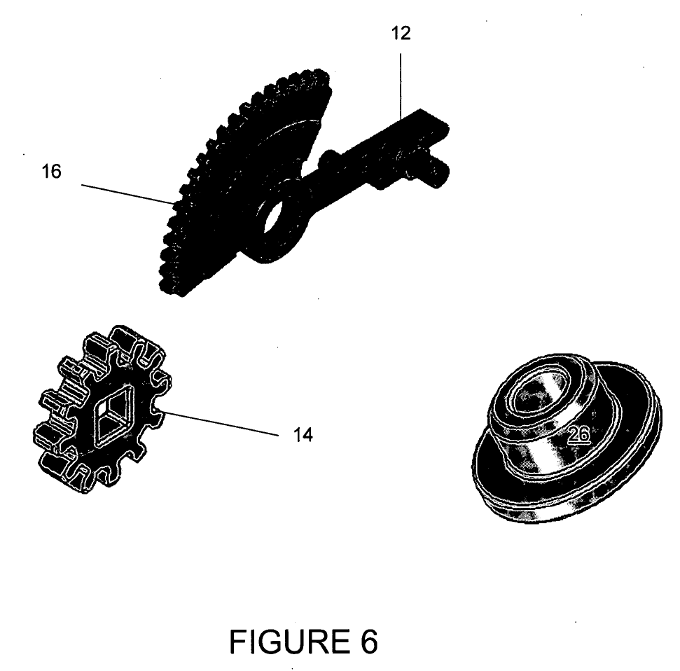

In an exemplary embodiment, the set of gears comprises a pinion gear 14 that engages a drive gear 16. As shown in FIG. 6, the drive gear teeth may comprise only a portion of a circle, and the lever arm 12 may extend from the other side. The drive gear 16 may rotate on a pivot bushing 26.

The present invention has numerous advantages. It is less expensive, does not require an upgraded alternator, interacts with the same basic components as the manual version of a PTO (thereby seamlessly interchanging with the manual version on assembly lines), has slower and smoother engagement than current electric PTO engagement mechanisms (thereby reducing shock on the belts on engagement), and is more reliable than the current electric version (thereby reducing warranty costs). The present invention may be presented as an option or an add-on for mowers.

Thus, it should be understood that the embodiments and examples have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. An electric power take off (PTO) device, comprising:
an electric motor;
a lever arm mechanically connected to the electric motor; and
a cable connected to an end of the lever arm;
wherein movement of the lever arm causes movement of the cable, and the movement of the cable results in the raising or lower of a cutting deck.

2. The device of claim 1, wherein the electric motor is bidirectional.

3. The device of claim 1, wherein the lever arm is mechanically connected to the electric motor by one or more gears.

4. The device of claim 3, wherein one of the gears is a pinion gear.

5. The device of claim 3, wherein one of the gears is a drive gear.

6. The device of claim 5, wherein the drive gear comprises a portion of a circle.

7. The device of claim 1, wherein the cable is looped around the end of the lever arm.

8. The device of claim 1, wherein the electric motor is controlled by a switch.

9. The device of claim 1, wherein the electric motor turns both forward and backward, causing the lever arm to move forward or backward in concert.

10. The device of claim 1, wherein the cable is connected to a fixed bracket, spring and idler pulley on the cutting deck.
